(19) United States
(12) Patent Application Publication
(10) Pub. No.: US 2025/0024126 A1
(43) Pub. Date: Jan. 16, 2025

(54) METHOD FOR MANUFACTURING A GLAZED UNIT INCLUDING A BASE INTENDED FOR A MOTOR VEHICLE DRIVER ASSISTANCE SYSTEM, BASE AND GLAZED UNIT

(71) Applicant: SAINT-GOBAIN GLASS FRANCE, COURBEVOIE (FR)

(72) Inventors: Laurent SILVESTRINI, COURBEVOIE (FR); Viktor SEIBEL, HERZOGENRATH (DE); Diederick DE RUITER, THE NETHERLANDS (NL)

(21) Appl. No.: 18/713,536

(22) PCT Filed: Nov. 21, 2022
(86) PCT No.: PCT/EP2022/082613

§ 371 Date: May 24, 2024

(30) Foreign Application Priority Data
Nov. 30, 2021 (FR) 2112753

(51) Int. Cl. H04N 23/54; B60J 1/00

(52) U.S. Cl. CPC H04N 23/54; B60J 1/001

(57) ABSTRACT

A method for manufacturing a glazed unit including a glazed element and a base intended for a vehicle driver assistance system, the base having a system for attaching the light sensor and a shutter position, the method including obtaining the base by three-dimensional printing; then depositing flocking including fibers on the shutter position; then attaching the base to the glazed element.

The invention relates to a method for manufacturing a glazed unit including a glazed element and a base for a light sensor of a vehicle driver assistance system, said system thus including a light sensor, such as a camera, said base having means for attaching said light sensor and a shutter position.

Known from the prior art is international patent application WO 2016/145431 A1 disclosing a camera system for assisting the driver of a motor vehicle in their driving. Such a system includes a base, intended to be attached to the windshield of the motor vehicle, wherein a front-facing camera is mounted. The field of view of the camera is therefore oriented toward the front of the motor vehicle. Such a system monitors the environment in order to collect and transmit information to processing systems integrated into the motor vehicle making it possible to analyze road signaling, the presence of a pedestrian or another vehicle, etc. In order to obtain images that can be used by the processing systems, it is important to reduce the reflection of light on the base in the field of view of the camera. For example, the light coming from the sun or the headlights of another vehicle can disrupt the quality of the images acquired by the camera. The base of the camera system includes a low-gloss camera screen including lateral walls and a lower wall so as to reduce the light reflection and thus form a closure. The walls are made from a material making it possible to reduce the light reflection or are covered with a material having anti-reflective properties. Such material may be, for example, rubber, silicone, a thermoplastic or an anti-reflective paint.

International patent application WO 2019/045991 is also known from the prior art, which discloses another motor vehicle driver assistance camera system. In this camera system, the anti-reflective function is obtained by means of a portion adjacent to the camera including a structured surface thus forming a closure. The structured surface has a first plurality of concave cavities, a second plurality of convex protrusions and a third plurality of concave cavities. These pluralities have different configurations and dimensions in order to obtain anti-reflection as shown in FIGS. 4 to 7 of this international patent application. The shutter manufactured in this way has a relatively high gloss index, of the order of 1.0 GU (“Gloss Unit”), or even more, for each of the reflection angles of the reflection system: 20°, 60° and 85°.

Such camera systems are intended to be mounted by the manufacturers of glazed units for motor vehicles on the windshields of new vehicles produced in very large series (several thousand to several million units). Therefore, these camera systems are well suited to manufacturing in large runs, for example by implementing, for manufacturing the base, a plastic injection process or molding. On the other hand, as regards the production of small runs, in particular dedicated to replacing windshields of vehicles in operation, this manufacturing process is not suitable for obvious reasons of implementation, complexity and cost, in particular when it is necessary to use plastic injection. Indeed, this method requires manufacturing an injection mold that is complex and costly to obtain.

Production means intended for small series, or even very small series, or even individually (for example, for the manufacture of prototypes), such as three-dimensional printing, also called additive manufacturing, are known. However, it is complicated, or even impossible, to obtain structures as seen previously, such as for example small-sized pins, or a specific surface grain or small ribs, by means of three-dimensional printing. It is known that three-dimensional printing does not allow surfaces to be produced that comprise elements requiring great production precision. The use of paints involves Environmental-Health and Safety problems because current standards require the use of specific paint cabins that are costly and bulky.

The purpose of the invention is therefore to overcome the disadvantages of the prior art by proposing a method for manufacturing a glazed unit making it possible to produce small series of glazed units, or even individual glazed units, adapted for a vehicle driver assistance system also having a simple and inexpensive means for attenuating the effective light reflection.

The present invention thus relates, in its broadest sense, to a method of making a vehicle glazed unit according to claim 1. This glazed unit includes a glazed element and a base intended for a vehicle driver assistance system, said system including a light sensor, in particular a camera, said base having means for attaching said light sensor and a shutter position, the method including the following successive steps:
a step of obtaining said base by three-dimensional printing;
then a step of depositing flocking including fibers, preferably black fibers, on said shutter position;
then a step of attaching said base to said glazed element, preferably a step of attaching said base to an inner face of said glazed element.

The method according to the invention makes it possible to produce small series of glazed units for a motor vehicle driver assistance system simply and in a relatively short time. It is also possible to manufacture such glazed units individually. In this way, when it is necessary to replace the glazed unit of a specific motor vehicle including a driver assistance system, the manufacture of the glazed unit including the base can be carried out in a short-time, for example near the place of replacement of the glazed unit. The motor vehicle is thus immobilized for a short period.

Preferably, prior to the step of depositing flocking:
a step of obtaining flocking film is carried out, said flocking film including flocking fibers on a first face, and on a second face an adhesive protected by a peelable film, then
a step of removing the peelable film is carried out.

The implementation of such a film, also called double-sided adhesive, provides an additional simplification to the method according to the invention.

Preferably, prior to the step of depositing flocking, a step of applying an adhesive to said shutter position is carried out. The flocking can then be in the form of a film supporting fibers, said film thus being then bonded by said adhesive.

Preferably, the step of depositing flocking is carried out by spraying electrostatically charged fibers.

The spraying of electrostatically charged fibers is easily implemented, making it possible to make the process even simpler.

The invention further relates to a base of a vehicle driver assistance camera system, obtained by the method according to the present invention, said system including a light sensor, in particular a camera, said base having means for attaching said light sensor and a shutter position including flocking including fibers, preferably black fibers.

Preferably, said flocking includes fibers having a length of between 0.5 and 0.8 mm in order not to come into contact with the inner face of said glazed element and not to cause reflections themselves.

Preferably, said flocking has a fiber density of between 250 and 750 fibers per mm² in order to achieve a better anti-reflective function.

Advantageously, said flocking includes a film including said fibers on a first face and an adhesive on a second face arranged in contact with said shutter position.

Advantageously, said shutter is recessed relative to an exterior face of said base and is therefore difficult to access. The flocking according to the invention is easy and quick to apply in this location that is difficult to access.

The invention further relates to a glazed unit obtained by the manufacturing process according to the invention and to a glazed unit including a glazed element and a base according to the invention, said base having means for attaching said light sensor and a shutter including flocking including fibers, preferably black fibers.

Described below, by way of non-limiting examples, will be several embodiments of the present invention referring to the appended figures in which:

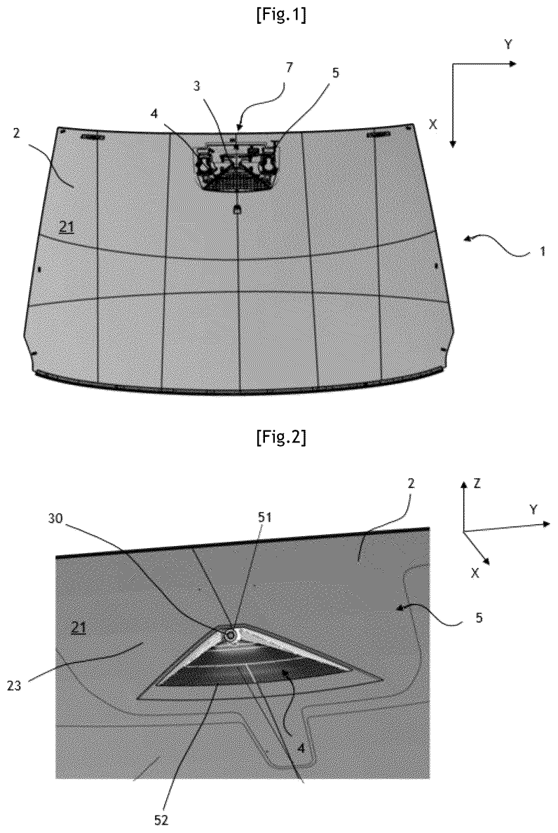

FIG. 1 shows a front view, from the outside, of a glazed unit, and more specifically here of a vehicle windshield, intended to be located in front of a vehicle, and in particular a motor vehicle and including a vehicle driver assistance camera system according to a preferred embodiment of the invention;

FIG. 2 schematically shows a detail view, from the outside, of the glazed unit shown in FIG. 1;

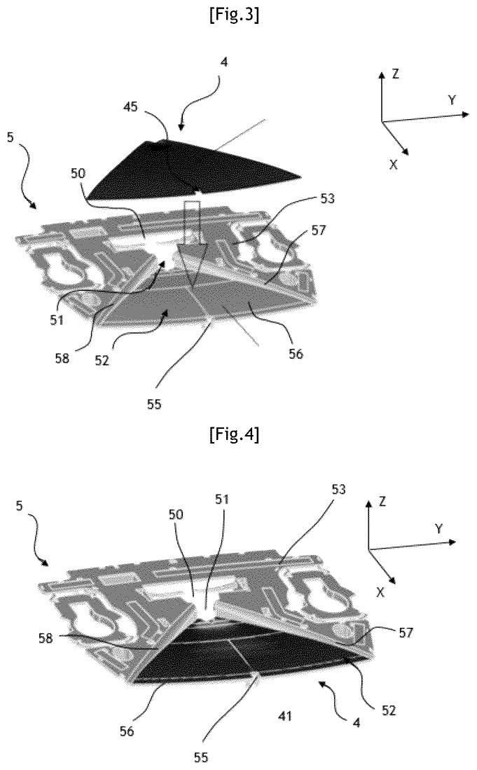

FIG. 3 shows a perspective view of a step of the manufacturing method according to the invention during which flocking is deposited on a shutter of a camera base according to the invention;

FIG. 4 represents a perspective view of the camera base including the flocking, following the implementation of the step of the manufacturing method shown in [FIG. 3]; and

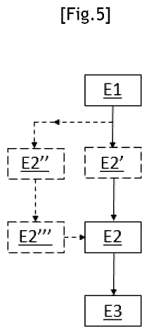

FIG. 5 represents in the form of a flowchart the steps of the manufacturing method according to the invention.

In these figures, individual elements in each figure are drawn to scale, and the background elements are shown by transparency in FIG. 1, in order to make them easier to read.

In the embodiment(s) of the invention, a glazed unit 1 including a glazed element 2 including one or more sheets is described. The glazed element 2 may be monolithic, in other words consisting of a single sheet of material, or may be composite, in other words consisting of several sheets of material between which at least one layer of adherent material is inserted, in the case of a laminated glazed element 2. The sheet(s) of material may be made of mineral material, in particular glass, having for example undergone annealing or tempering, or of organic material, particularly of plastic material such as polyvinyl butyral. The interlayer preferably contains at least one thermoplastic plastic material, preferably polyvinyl butyral (PVB), ethylene-vinyl acetate (EVA), and/or polyethylene terephthalate (PET). However, the thermoplastic interlayer may also contain, for example, polyurethane (PU), polypropylene (PP), polyacrylate, polyethylene (PE), polycarbonate (PC), polymethyl methacrylate, polyvinyl chloride, polyacetate resin, casting resins, acrylates, fluorinated ethylene propylene, polyvinyl fluoride and/or ethylene-tetrafluoroethylene, or copolymers or mixtures thereof. The thermoplastic interlayer may be formed from one or more superimposed thermoplastic films, the thickness of a thermoplastic film not exceeding, preferably, 1 mm, in particular 0.25 mm or 0.5 mm to 1 mm or 0.9 mm, typically around 0.7 mm to 0.8 mm.

[FIG. 1] shows a top view of a glazed unit 1 of a vehicle, such as for example a motor vehicle, including a vehicle driver assistance system 7 according to one embodiment of the invention.

The glazed unit 1 thus includes, in addition to the glazed element 2, a base 5 which is intended to allow the mechanical and reversible attaching of an accessory, and preferably as shown here, the attaching of several accessories, at least one of which is a light sensor.

The glazed unit 1 is intended to close an opening that forms a separation between an internal space, located inside the vehicle, and an external space, located outside the vehicle. The glazed element 2 thus has an external face 21 intended to be turned toward the external space, an internal face, intended to be turned toward the internal space, as well as a narrow peripheral edge. The concepts of “exterior” and “interior” are therefore respectively considered in the present document with respect to this external space (or oriented towards this external space) and this internal space (or oriented towards this internal space).

The glazed unit 1 extends along the axis generally called the “X axis” of the motor vehicle, which is the central longitudinal axis of the front of the motor vehicle equipped with the glazed unit according to the invention and which corresponds to the X axis in [FIG. 1] to [FIG. 4]. The glazed unit 1 further extends along the axes Y and Z, which are respectively the transverse axis and the vertical axis of the motor vehicle.

The glazed element 2 may be planar or curved.

The base 5, otherwise called “plate” or “bracket”, must allow the light sensor to be reversibly attached to the glazed element 2, which is accessible through the interior of the vehicle. In general, this light sensor is not directly accessible to the user located inside the vehicle and is hidden under a hood.

This base must make it possible to reversibly attach to the glazed element this light sensor which can be qualified as “outwardly oriented light sensor” in the sense that it must be positioned with an outwardly oriented part of the vehicle, facing an interior face of the glazed element 2; this may for example be a sensor intended to capture light information coming from the outside.

In other words, the invention is located in the technical field of bases, or plates, for attaching one or more accessories, at least one of which is an interior light sensor with an exterior view and including at least one recess, for the accommodation and attaching of this light sensor with exterior aiming, said base further including:
an aiming part 51, without a base material, which allows the light sensor to capture visible and/or infrared light coming from the outside, and
a shutter 52, consisting of an outwardly facing part for the purpose of decreasing or preventing reflections that would be harmful to the correct function of the part of the light sensor located in the aiming part.

This light sensor may in particular be an optical sensor and in particular a camera.

Preferably, the base 5 is arranged substantially in the median part of the glazed unit 1, toward its upper part when the glazed unit 1 is installed in the vehicle opening. Thus, the base 5 does not hinder the vision of the driver of the vehicle. The base 5 is mostly hidden, seen from the outside, behind an opaque layer 23, such as for example a black enamel layer, belonging to the glazed element 2, except its shutter 52. The base 5 is hidden from the inside behind a cover (not shown).

The base 5 is made of plastic material and has a body, an exterior face 53 intended to be located facing the interior face of the glazed element, an interior face turned towards the interior and a recess 50 for attaching the light sensor opposite the interior face of the glazed element so that it can capture through the glazed element 2.

The body is located between the external face 53 and the internal face; it denotes the constituent material of the base that is located between the two faces thereof and which is covered by these faces. The present invention is particularly suitable when the glazed element is curved because the exterior face 53 is then difficult to produce because it must follow the curvature of the glazed element.

The recess 50 is a location of the base 5 where there is a depression or hole of a particular shape because it is intended to allow the positioning of the aforementioned light sensor as well as means for reversibly attaching this light sensor to the base 5, such as hooks or lugs or clips.

The system 7 is connected to a controller responsible for analyzing the images coming from the light sensor, which here is a camera 3 having a lens 31 located in the aiming part 51 when the camera is attached to the base 5, as can be seen in [FIG. 2]. The controller interacts with devices installed on the motor vehicle that are dedicated to assistance, such as a lane-keeping alert, emergency braking device in response to the detection of a pedestrian or a warning of exceeding maximum speed in response to the analysis of a speed limiting panel.

The lens 30 of the camera 3 is oriented frontward when the system 7 is installed on the vehicle. Thus, the camera 3 acquires images coming from the front of the vehicle. Although the present invention is described for a front-facing system 7, it is also applicable to other configurations having a different field of view such as a system 7 oriented toward the rear or towards one of the sides of the vehicle, or even several sides when several systems 7 are implemented.

The shutter 52 includes a substantially planar surface 56, extending from the aiming part 51 towards the interior face of the glazed element downwards, as well as two lateral walls 57 and 58, also extending from the aiming part 51 towards the interior face of the glazed element toward the sides.

The shutter 52 includes flocking 4 in order to reduce, or even eliminate, the reflection of light coming from the outside, such as sunlight, which can degrade the quality of the images acquired by the camera 3. Preferably, the flocking 4 includes fibers having a length of between 0.5 and 0.8 mm, or even between 0.6 and 0.7 mm. Thus, undesirable reflections are picked up, or absorbed, by the flocking and the fibers are short enough so as not to come into contact with the interior face of the glazed element and not risk causing undesirable reflections.

Preferably, the flocking 4 has a density of between 250 and 750 fibers per mm² in order to properly attenuate, and preferably eliminate, undesirable reflections. Preferably, the fibers are arranged substantially perpendicularly relative to the surface 56 of the shutter. Preferably, the fibers are black in color so as not to cause micro-reflection. Preferably, the fibers are made of a polyamide or polyethersulfone-based material.

The flocking 4 has a gloss index of less than or equal to 0.3 GU for each of the reflection system reflection angles; 20°, 60° and 85° (the gloss index less than or equal to 0.3 GU for the angle of reflection of the 85° measurement system is the most difficult to obtain). The flocking 4 thus makes it possible to greatly reduce the light reflection in comparison with the assistance systems of the prior art having a gloss index of less than or equal to 1.0 GU. The invention thus has the advantage of improving the quality of the images acquired by the camera 3. Therefore, the driver assistance is significantly improved.

The flocking is present on at least part, and preferably all of the substantially planar surface 56, of the shutter 52; it may also be present on the side walls 57 and 58 of the shutter position 52.

In an alternative embodiment (not shown), a film includes the flocking 4 on a first outwardly oriented face and has a second face that is oriented toward the shutter position 52. The film is bonded to the shutter position 52 by means of an adhesive. Preferably, the film is made from a material such as polyolefin, polypropylene or polyamide.

In the embodiment presented, the flocking 4 is distributed substantially uniformly over the entire surface 56, according to a triangular shaped geometry without being present on the lateral walls 57 and 58 of the shutter position 52. The flocking 4 may have other geometric configurations in order to adapt to the geometry of the shutter present in other motor-vehicle driver assistance camera systems 7.

The invention further relates to a method for manufacturing the glazed unit 1 including the glazed element 2 and the base 5 intended for the vehicle driver assistance camera system 7; the base 5 according to the invention can nevertheless be manufactured according to another method making it possible to easily produce small series. Various steps of the method are presented in [FIG. 5].

In a step E1 of the method according to the invention, the base 5 is manufactured in small series, or even individually, by a three-dimensional printing means. For example, a three-dimensional printer may be implemented using:
deposition of wire or wire extrusion: a plastic filament is melted and deposited on a printing build plate, forming the base layer after layer;
photopolymerization: a laser or a light source solidifies a liquid and photosensitive resin, point by point or layer by layer to form the base;
melting of powder: a laser fuses particles of powder dots point by point to form the base.

This step E1 can make it possible to obtain a base made of an opaque and matt material, that is to say non-gloss and with a low reflective power. This material can be black, and in particular matt black.

This step E1 of manufacturing the base can be carried out in situ, on the glazed element 2, in order to save time, but this requires a machine of large size, compatible with the dimension of the glazed element.

During a step E2, the flocking 4 is placed on the shutter position 52 of the base 5 so as to form the shutter. The double arrow in [FIG. 3] shows this step E2. This step can be carried out by first applying an adhesive on the shutter position 52 and then a film including fibers on this adhesive or by applying to the shutter position 52 a film including fibers on an exterior face and adhesive on an interior face.

Preferably, before the step E2 of depositing the flocking 4, during a step E2″, a film is obtained including flocking fibers on a first face, and on a second face an adhesive protected by a peelable element. Then, during a step E2″′, the peelable element is removed.

The flocking 4 has the shape of a triangle and includes, on the base of the triangle, a cutout 45. The shutter position 52 has a triangular shape intended to receive the flocking 4, cooperating with the triangular shape of the flocking 4. The shutter position 52 further includes a lug 55 arranged substantially in the middle of the base of the triangle intended to receive the cutout 45 of the flocking 4. The cutout 45 and the lug 55 have dimensions making it possible to cooperate with one another. Preferably, the cutout 45 has a substantially rectangular female shape and the lug 55 has a substantially rectangular male shape. During step E2 of the deposition of the flocking 4 on the shutter position 52, the lug 55 fits into the cutout 45. Alternatively, other geometric shapes may also be suitable such as the shape of a square, a circle or a triangle. The cutout 45 and the lug 55 thus form a positioning reference marker for the flocking 4 during the step E2 of depositing the flocking 4.

Alternatively, the flocking 4 is deposited by spraying, by electrostatically charging the flocking fibers 4. Preferably, during a step E2′, before the step E2 of depositing the flocking 4, an adhesive is then applied on the shutter position 52 able to retain the flocking fibers 4.

[FIG. 4] shows the base 5 including the flocking 4. In a subsequent step (not shown), the camera 3 is integrated in order to obtain a motor vehicle driver assistance camera system 7 and, optionally, other devices such as a rain sensor or a light sensor. In particular, this may be the camera that was present on another glazed element of the vehicle when it is desired to replace the glazed element while keeping the camera. The base 5 is finally attached to the glazed element 2 in order to obtain the glazed unit 1.

The method according to the invention has the advantage of facilitating the manufacture of the base of the vehicle driver assistance camera system. The method allows rapid and simple deposition of the anti-reflective flocking. Indeed, in the state of the art, plastic injection production means require the manufacture of molds that are relatively complex to obtain. Regarding the anti-reflective function, in the prior art, processes are implemented that are not suitable for the production of small runs such as depositing a paint, obtaining ribs by plastic injection, applying a sheet of rubber (EPDM), obtaining surfaces having a very fine particle size or applying a sheet of thermoplastic (vulcanized olefinic TPV). The method according to the invention consequently makes it possible to dispense with complex means to implement for small-scale manufacturing or for individual manufacturing of a glazed unit including a base of a vehicle driver assistance camera system.

The base 5 is intended to be attached in a step E3, for example by bonding, on the interior face of the glazed element 2 having in a localized manner a black enamel, except at the location opposite the shutter position. The glazed unit 1 is then installed in the opening of the motor vehicle.

1. A method for manufacturing a glazed unit including a glazed element and a base intended for a vehicle driver assistance system, said vehicle driver assistance system including a light sensor, said base having means for attaching said light sensor and a shutter position, the method comprising successively:
obtaining said base by three-dimensional printing;
then depositing flocking including fibers on said shutter position;
then attaching said base to said glazed element.

2. The method according to claim 1, wherein, prior to depositing flocking, the method comprises:
obtaining a flocking film, said flocking film including flocking fibers on a first face and on a second face an adhesive protected by a peelable film, then
a removing the peelable film.

3. The method according to claim 1, wherein, prior to depositing flocking, the method further comprises applying an adhesive to said shutter position.

4. The method according to claim 3, wherein depositing of flocking is carried out by spraying electrostatically charged fibers.

5. A base for a vehicle driver assistance camera system, obtained by the method according to claim 1, said vehicle driver assistance camera system including a light sensor, said base having means for attaching said light sensor and a shutter position including flocking including fibers.

6. The base according to claim 5, wherein said fibers have a length of between 0.5 and 0.8 mm.

7. The base according to claim 5, wherein said flocking has a fiber density comprised between 250 and 750 fibers per mm².

8. The base according to claim 5, wherein said flocking includes a film including said fibers on a first face and an adhesive on a second face arranged in contact with said shutter position.

9. The base according to claim 5, wherein said shutter position (52) is recessed relative to an exterior face of said base.

10. A glazed unit including a glazed element and a base according to claim 5.

11. The method according to claim 1, wherein the light sensor is a camera.

12. The method according to claim 1, wherein the fibers are black fibers.

13. The method according to claim 1, wherein said attaching said base to said glazed element includes attaching said base to an inner face of said glazed element.

14. The base according to claim 5, wherein the light sensor is a camera.

15. The base according to claim 5, wherein the fibers are black fibers.
